(19) United States
(12) Patent Application Publication
(10) Pub. No.: US 2012/0019169 A1
(43) Pub. Date: Jan. 26, 2012

(54) DIMMABLE AMALGAM LAMP AND METHOD FOR OPERATING THE AMALGAM LAMP WHILE DIMMED

(75) Inventors: Alex Voronov, Hanau (DE); Klaus Spitzenberg, Mainhausen (DE); Franz-Josef Schilling, Freigericht (DE)

(73) Assignee: HERAEUS NOBLELIGHT GMBH, Hanau (DE)

(21) Appl. No.: 13/258,535

(22) PCT Filed: Feb. 26, 2010
(86) PCT No.: PCT/EP2010/001181

§ 371 Date: Sep. 22, 2011

(30) Foreign Application Priority Data
Mar. 30, 2009 (DE) 10 2009 014 942.2

(51) Int. Cl. H05B 41/36; H01J 61/24

(52) U.S. Cl. 315/307; 313/552

(57) ABSTRACT

A dimmable amalgam lamp is provided having a quartz glass tube enclosing a discharge chamber comprising a filling gas, and closed by pinching at both ends thereof, through which at least one current feedthrough is fed through one coil-shaped electrode each in the discharge chamber, wherein at least one of the pinches has a hollow space having an opening to the discharge chamber for receiving a deposit of amalgam that can be heated by the coil-shaped electrode. In order to provide a method for operating the amalgam lamp on this basis, ensuring a high efficiency of UV-C radiation even when dimmed, the invention proposes that the current feedthrough include an outgoing line and a return line for an additional current I_{add}, and that the additional current I_{add} is adjusted as a function of the level of the actual lamp current I_{actual}.

### CROSS-REFERENCE TO RELATED APPLICATIONS

This application is a Section 371 of International Application No. PCT/EP2010/001181, filed Feb. 26, 2010, which was published in the German language on Oct. 7, 2010, under International Publication No. WO 2010/112112 A1 and the disclosure of which is incorporated herein by reference.

### BACKGROUND OF THE INVENTION

The invention relates to a dimmable amalgam lamp having a quartz glass tube, which surrounds a discharge chamber containing a filler gas and which is closed with pinches at its two ends, through which at least one current feedthrough is guided to each coil-shaped electrode in the discharge chamber, wherein at least one of the pinches has a hollow chamber having an opening to the discharge space for holding an amalgam deposit, which can be heated by the coil-shaped electrode.

The invention further relates to a method for operating an amalgam lamp while dimmed.

Such amalgam lamps involve low-pressure mercury lamps, in which amalgam is used for the purpose of increasing performance. Amalgam lamps are used for technologically demanding applications, which deal with high UV irradiation densities and high operating reliability, as for example, for UV sterilization and for oxidation.

Here, in addition to the filler gas, a deposit made of solid amalgam is also inserted into the discharge chamber. The effect of the amalgam is to control the mercury vapor pressure within the discharge chamber enclosed by the lamp body.

Such an amalgam lamp is known from U.S. patent application publication No. 2006/267495 A1. This consists of a quartz glass tube made of quartz glass, which is closed on both ends with pinches, through which a current feedthrough is arranged in the discharge chamber for a coil-shaped electrode. For introducing an amalgam deposit, it is proposed to enclose amalgam in an additional container, which is open toward the discharge chamber. The additional container is positioned behind one of the electrodes. Because the container is open toward the filler gas, the solid amalgam is in thermodynamic equilibrium with the filler gas of the lamp. The additional container projects into the discharge chamber either through the lateral cylinder surface of the quartz glass tube or through one of the pinches. Here, an additional fixing of the amalgam deposit in the additional container is provided by a fused-in, hook-shaped holder.

The fusing of the additional container for holding the amalgam deposit requires an additional processing step and is associated with the risk of loss of the quartz-glass tube.

An amalgam lamp of the type cited above, such as that known from International Publication No. WO 2007/091187 A1, avoids this disadvantage. It is proposed to provide one of the pinches with a hollow space open toward the discharge chamber, wherein the amalgam deposit is inserted into this hollow space. In an alternative embodiment it is provided that the amalgam deposit is inserted in a spherical container, which has an opening toward the top and is held by a metal strip embedded in the pinch. The metal strip simultaneously projects into the spherical container and anchors the amalgam deposit therein.

In the vicinity of the amalgam deposit there is a heating coil, which provides its own power circuit and a temperature controller. In this way, the amalgam deposit can be kept at a certain temperature, and thus the highest possible efficiency of the amalgam lamp can be ensured.

One special problem arises when the amalgam lamp is dimmed. For amalgam lamps in which the amalgam deposit is located on the inner wall of the discharge chamber, the amalgam has an optimal temperature at the rated lamp output and therefore ensures an optimal mercury-vapor pressure. When dimmed, however, the heat flow from the discharge area between the electrodes to the amalgam deposit decreases, so that this becomes colder and the mercury-vapor pressure and the efficiency of the amalgam lamp decrease.

With the amalgam lamp known from WO 2007/091187 A1, the cooling of the amalgam deposit is counteracted by detecting the temperature in the region of the amalgam and the degree of dimming, and by carrying out a corresponding regulation of the temperature of the separate heating device.

The separate heating device and the temperature measurement and regulation device, however, demand considerable extra structural expense.

### BRIEF SUMMARY OF THE INVENTION

The invention is thus based on the object of providing a structurally simple amalgam lamp, which maintains a high efficiency of the UV-C emission, even when operating at lower output (dimming).

In addition, the invention is based on the object of providing a procedure for operating the amalgam lamp while dimmed, which ensures a high efficiency of the UV-C radiation.

With respect to the amalgam lamp, this object is achieved according to the invention starting from an amalgam lamp having the features of the type cited above, in that the current feedthrough for the coil-shaped electrode comprises an outgoing line and a return line for a heating current I_{add}, wherein a control device is provided by which the heating current I_{add} can be adjusted as a function of the magnitude of the actual lamp current I_{actual}.

Heating the amalgam deposit serves to generate a mercury vapor pressure in the discharge chamber, which is independent of the actual output of the amalgam lamp and ensures an optimal efficiency for the UV radiation. This produces a region of optimal temperature of the amalgam, which is independent of the nominal output of the amalgam lamp.

For heating the amalgam deposit, the coil-shaped electrode placed adjacent to the amalgam deposit is used. This thus serves both for generating an electric arc and also for maintaining a specified temperature of the amalgam deposit.

During operation the electric arc attacks the surface of the electrode, so that this is heated by the electric arc. This heating is dependent on the output of the electric arc and is transferred to the amalgam deposit through heat radiation. In comparison, the contribution of the electric arc for heating the amalgam deposit is low.

Thus, for the amalgam lamp according to the invention, heating of the amalgam deposit enclosed in the pinch is provided by the heated electrode, without an expensive, additional heating device or the like having to be provided for this purpose.

When the amalgam lamp is dimmed, however, the lamp current decreases from the nominal value Iₙₒₘᵢₙₐₗ (100% output) to a lower value, and the heating current from the coil to the amalgam deposit decreases accordingly, whereby this amalgam deposit no longer reaches the specified temperature. Thus, the vapor pressure of the mercury within the discharge chamber decreases and thus also the UV-C emissions to a value below the optimum.

To compensate for this heat loss, according to the invention, an additional current is sent through the coil-shaped electrode. The additional current heats the coil-shaped electrode, which is located in the vicinity of the amalgam deposit, above the temperature which would otherwise be set for a dimmed lamp output.

The magnitude of the additional current depends on the difference between the nominal output and the required output when dimmed. It has proven effective if the control device is provided for the purpose of adjusting the additional current “I_{add}” according to specification of the following relationship:

½I ₙₒₘᵢₙₐₗ<I_{actual}+I_{add}<2 Iₙₒₘᵢₙₐₗ (1)

The control device is used to adjust the additional current so that an optimal temperature of the amalgam deposit is maintained even in dimmed operation, and thus a high efficiency of the UV-C emission can be achieved. If the sum of the additional current and actual lamp current during dimmed operation is greater than 2-times the nominal lamp current, then the amalgam will overheat. If the sum of the additional current and actual lamp current during dimmed operation is less than 0.5-times the nominal lamp current, then the amalgam deposit will become, in contrast, too cold. In both cases, the efficiency of the UV-C emissions decreases. It has been shown that under these boundary conditions, expensive temperature control for the temperature of the electrode or of the amalgam deposit can be eliminated.

In the ideal case the additional current is adjusted by the control device as a function of the dimmed actual lamp current, so that the sum of the additional current and actual lamp current corresponds exactly to the nominal lamp current. Preferably, the deviations from this ideal value lie in the range of +/−10% (with respect to the nominal lamp current). Accordingly, an embodiment of the amalgam lamp is especially preferred in which the control device is suitable for setting the additional current “I_{add}” according to the specification of the following relationship:

I_{add}+I_{actual}=Iₙₒₘᵢₙₐₗ±0.1 Iₙₒₘᵢₙₐₗ (2)

An additional current in this range ensures a maximum efficiency of the UV-C emission both during operation with nominal lamp output and also during operation with dimmed amalgam lamp.

For an especially preferred construction of the amalgam lamp according to the invention it is provided that the amalgam lamp has a distance “L” (in m) from the coil-shaped electrode, wherein this distance is set as a function of the nominal lamp current with reference to the following equation:

\sqrt{2kIₙₒₘᵢₙₐₗ}≧L≧\sqrt{1/2kIₙₒₘᵢₙₐₗ} (3)

where Iₙₒₘᵢₙₐₗ (in A) is the nominal lamp current of the amalgam lamp and the constant k=0.25×10⁻³ (in m²/A).

In the heating of the amalgam deposit enclosed in the pinch, the distance between the amalgam deposit and the coil-shaped electrode plays a significant role. This results because the greater the nominal lamp current is, the higher the temperature of the electrode is during operation of the amalgam lamp, and the greater the distance between the electrode and the amalgam deposit must be, in order to adjust the temperature in the region of the amalgam deposit to the desired level and to prevent overheating of the amalgam. Overheating can lead to a deviation from the optimal mercury vapor pressure and thus to a decrease of the efficiency of the emitted UV-C radiation.

According to the invention, it is therefore provided that the amalgam deposit has a distance from the coil-shaped electrode, which is set as a function of the nominal lamp current with reference to the following equation:

\sqrt{2kIₙₒₘᵢₙₐₗ}≧L≧\sqrt{1/2kIₙₒₘᵢₙₐₗ} (3)

where Iₙₒₘᵢₙₐₗ (in A) is the nominal lamp current and the constant k=0.25×10⁻³ (in m²/A).

Here, as the distance between the amalgam deposit and the coil-shaped electrode, the section between the emitter longitudinal axis positions of the coil and amalgam deposit is understood, and indeed the longitudinal axis position of the outside of the coil facing the electric arc and the longitudinal axis position of the outside of the amalgam deposit facing the electrode, as is shown schematically in FIG. 1. The distance is fixed by the length of the current feed lines for the coil-shaped electrode and by the diameter of the coil. Thus, for equal coil diameters only the length of the current feed lines, which are also called “legs” below, to the electrode is decisive.

For a small distance it can occur that the amalgam deposit becomes overheated; and for a distance above the mentioned range there arises the risk that the amalgam remains too cold. In both cases, the efficiency of the UV emission decreases.

With one especially preferred embodiment of the amalgam lamp according to the invention, it is provided that the distance “L” (in m) between the amalgam deposit and coil-shaped electrode is set by reference to the following equation:

L=\sqrt{kIₙₒₘᵢₙₐₗ}±0.2 \sqrt{kIₙₒₘᵢₙₐₗ} (4)

According to the invention, the pinch is provided with a hollow space within which the amalgam deposit is held. In the simplest case, the hollow space is formed with the use of a special mold during the production of the pinch. In this hollow space, the amalgam deposit is reliably fixed, so that it cannot escape from this space even for tilted positions of the amalgam lamp.

For fixing the amalgam deposit within the hollow space, a measure is preferred in which the hollows space opening has an opening width, which is impassable for the amalgam deposit.

The amalgam deposit exists as a massive solid body and has a shape and size that prevents discharge from the hollow space opening into the discharge chamber as a solid. The placement of the amalgam deposit in the hollow space here requires the introduction of amalgam in a flowable state and a subsequent solidification into the amalgam solid body, which completely or partially fills up the hollow space. One measure suitable here is explained in more detail farther below with reference to an embodiment.

Alternatively or additionally, it has also proven favorable if a holding element, which is anchored with the amalgam deposit, projects into the hollow space.

The holding element contributes to the fixing or additional anchoring of the amalgam deposit within the hollow space and is preferably embedded at least partially in the related pinch.

Here, a first embodiment of the amalgam deposit has proven itself, in which the holding element is made of quartz glass and is guided from the outside through the pinch into the hollow space.

The holding element here has a longitudinally elongated cylindrical part, which extends through the pinch and allows handling and alignment of the holding element before production of the pinch. The holding element furthermore has a part that projects into the hollow space and can be provided with a hook and is used for anchoring the amalgam deposit. The holding element comprises quartz glass, so that differences between the thermal expansion coefficients of the holding element and the material of the pinch, which likewise involves quartz glass, are avoided.

In an alternative and equally preferred embodiment of the amalgam lamp according to the invention, it is provided that the holding element comprises metal and is connected to a current feed line of the electrode.

The metallic holding element is here welded with a feed line for the power supply of the electrode. This produces a specified position of the holding element with reference to the hollow space to be produced. Therefore, for the production of the pinch it is to be ensured that the free end of the holding element comes to lie in the hollow space to be produced. On the other hand, the introduction and alignment of a holding element in an additional processing step is eliminated.

With respect to the method for operating the amalgam lamp according to the invention when dimmed, the object cited above is achieved in that the current feedthrough for the coil-shaped electrode comprises an outgoing line and a return line for an additional current I_{add} and, in that the additional current I_{add} is adjusted as a function of the magnitude of the actual lamp current I_{actual}.

Through this operation it can be ensured that, even when the amalgam lamp is dimmed, the amalgam deposit is kept at a temperature which ensures a high efficiency of the UV-C radiation. This results because, when dimmed, the nominal lamp current Iₙₒₘᵢₙₐₗ (corresponds to 100% of the lamp output) is reduced to a lower value, so that the coil-shaped electrode assumes a lower temperature and thus the amalgam deposit, which is heated by this electrode according to the invention, also cools.

According to the invention, an additional current is conducted through the coil-shaped electrode, which depends on the difference between the nominal output of the amalgam lamp and the required output when dimmed.

Preferably, the heating current “I_{add}” is adjusted according to the specification of the following relationship:

½Iₙₒₘᵢₙₐₗ<I_{actual}+I_{add}<2 Iₙₒₘᵢₙₐₗ (1)

By setting the additional current within the range defined in equation (1), an optimal temperature of the amalgam deposit is maintained and thus a high efficiency of the UV-C emission. For an additional current below the mentioned lower limit, the risk arises that the amalgam will become too cold, so that the mercury vapor pressure and consequently the UV-C emission decreases; for an additional current above the mentioned upper limit of the range, the risk arises, in contrast, that the mercury vapor pressure will become too high, which likewise leads to a reduction of the UV-C emission. It has been shown that an expensive temperature setting for the amalgam deposit can be eliminated even for dimmed operation of the lamp.

Here, the additional current I_{add} is adjusted in the ideal case so that the sum of the additional current and actual lamp current corresponds exactly to the nominal lamp current. Slight deviations from this ideal case can be easily managed, for example deviations in the range of +/−10% of the nominal lamp current. Accordingly, a method for operating the amalgam lamp is especially preferred in which the additional current is adjusted according to the specification of the following relationship:

I_{add}+I_{actual}=Iₙₒₘᵢₙₐₗ±0.1 Iₙₒₘᵢₙₐₗ (2)

With an operation of the amalgam lamp in this range an optimal high efficiency of the UV-C emission is enabled both during operation at nominal lamp output and also for a dimmed amalgam lamp.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is schematic front detail view of an embodiment of an amalgam lamp according to the invention;

FIG. 2 is a schematic, sectional side detail view of the embodiment according to FIG. 1 taken along the line A-A o FIG. 1;

FIG. 3 is a schematic side sectional detail view of another embodiment of an amalgam lamp according to the invention;

FIG. 4 is schematic front detail view of another embodiment of an amalgam lamp according to the invention; and

FIG. 5 is a schematic detail view of an embodiment of an amalgam lamp according to the invention having a circuit diagram, which shows one part of the power supply.

### DETAILED DESCRIPTION OF THE INVENTION

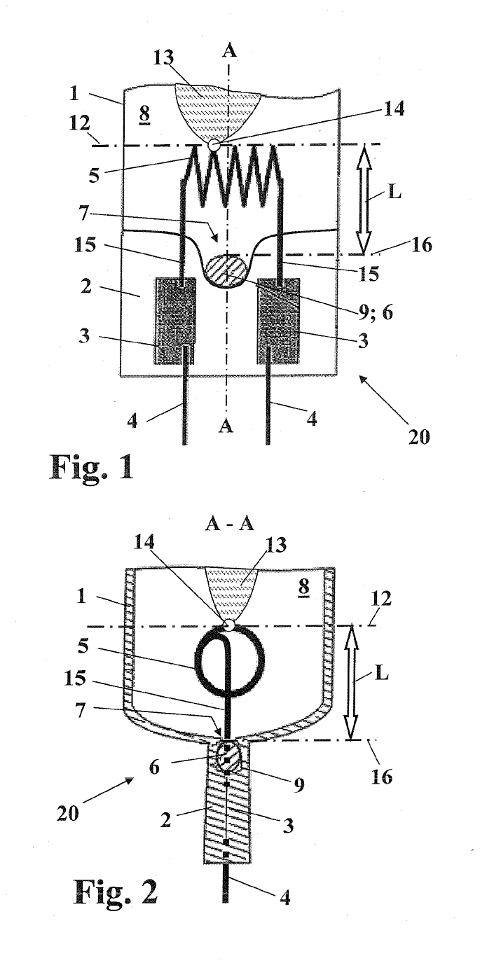

FIG. 1 shows schematically one of the two ends of an amalgam lamp 20, which distinguishes itself by a nominal output of 800 W (at a nominal lamp current of 8 A), an emitter length of 150 cm, and thus by a power density of approximately less than 5 W/cm. It comprises a quartz glass tube 1, which is closed at its ends with pinches 2, in which molybdenum foils 3 as well as the ends of metallic terminals 4 to a coil-shaped electrode 5 are embedded. For this purpose, the electrode 5 has “legs” 15, which are connected to the molybdenum foil 3.

Between the electrode 5 and a second opposing electrode (not shown in FIG. 1), during operation an electric arc 13 is generated, whose foot 14 ends on the surface of the electrode 5. The upper edge of the electrode, on which the foot 14 of the electric arc 13 attacks, is designated with a dashed line 12.

The pinch 2 at the shown end is provided with a hollow space 9, which is used as a holder for an amalgam deposit 6. The hollow space 9 has an opening 7 to the discharge chamber 8. The opening width of the opening 7 is significantly narrower than the maximum open width of the hollow space 9 and is also narrower than the maximum diameter of the amalgam deposit 6, so that the amalgam is trapped in the hollow space 9 and cannot pass in solid form into the discharge chamber 8. In the embodiment, the maximum opening width of the opening 7 lies at 2 mm.

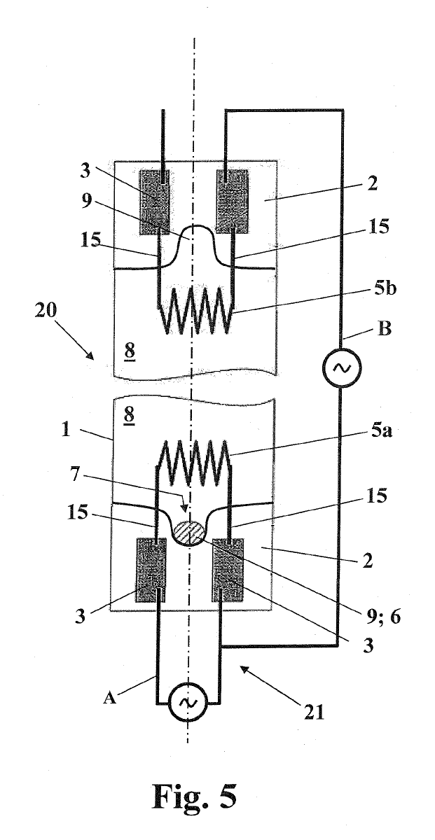

In this way, the amalgam deposit 6 is fixed in the vicinity of the electrode 5. The electrode 5 is heated by the electric arc 13 to a temperature which depends on the actual output of the amalgam lamp 20 (see also FIG. 5) and acts on the amalgam deposit 6 according to distance L. The distance L between the amalgam deposit 6 and the longitudinal position 12 of the foot 14 is determined with reference to the following equation:

L=\sqrt{kIₙₒₘᵢₙₐₗ,}

where k=0.25×10⁻³ (in m²/A). For the amalgam lamp 20 in the embodiment, the distance L equals approximately 4.5 cm. According to the invention, this distance is set as a function of the nominal lamp current, which is carried out in practice by adjusting the length of the legs 15. The distance L is measured between the upper edge 12 of the electrode coil and the upper edge 16 of the amalgam deposit, as indicated by the block arrow “L”.

The amalgam lamp 20 is equipped with a dimming and control device (not shown in the Fig.), which is explained in more detail below with reference to FIG. 5.

From the view of FIG. 2 it is clear that the opening 7 of the hollow space 9 is narrowed in this direction of view, so that the amalgam deposit cannot pass the opening 7.

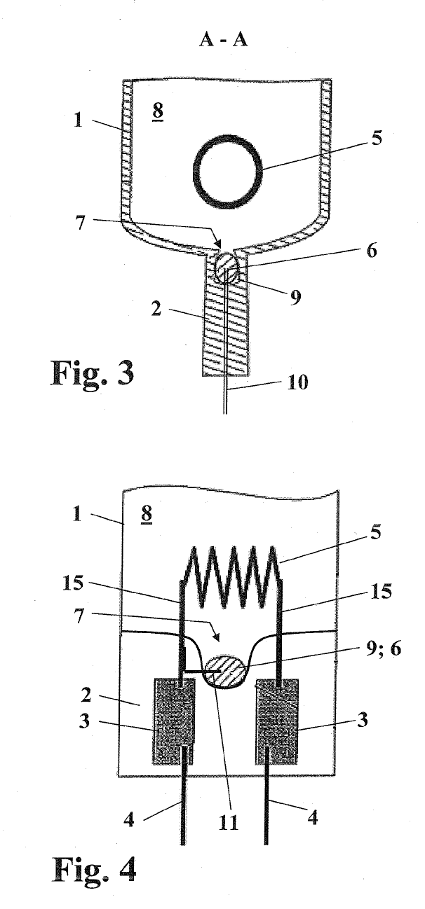

In FIG. 3 a supplemental fixing of the amalgam deposit 6 by a quartz glass fiber 10 is provided schematically, which extends through the pinch 2 into the amalgam deposit 6 and forms a uniform quartz glass mass with the pinch after production of this pinch.

FIG. 4 shows another embodiment of the amalgam lamp according to the invention, in which the amalgam deposit 6 is fixed additionally by a metallic hook 11 in the hollow space 9. The hook 11 is welded on one of the legs 15 for the electrode 5 and its free end extends into the amalgam 6.

In the following, the production of the amalgam lamp will be explained in detail with reference to an embodiment:

Electrodes 5 are inserted in a quartz glass tube and the two ends are closed with pinches 2. For the production of a pinch 2 a mold is used, which has a recess that generates the pinch 2 including the hollow space 9. Here, the current terminal 4, 3; 15 for the electrode 5 is simultaneously embedded in a vacuum-tight manner. By an opening in the side wall of the quartz glass tube 1, which is to be closed again at a later time, solid amalgam is placed on the opening 7 of the hollow space 9 and then softened. The amalgam thereby flows into the hollow space 9 and solidifies into a solid amalgam deposit 6. Here, it is essential that the amalgam deposit 6 have a size after solidification that prevents the amalgam mass from reaching past the narrowed opening 7 into the discharge chamber 8.

In the following, the dimmable amalgam lamp 20 according to the invention and a procedure for dimmed operation will be explained in detail with reference to FIG. 5. FIG. 5 shows the ends of the discharge space 8 (shown broken) of the amalgam lamp 20 according to FIG. 1 with the opposing coil-shaped electrodes 5a, 5b in the discharge chamber 8, wherein the electrical terminals of these electrodes are guided through the pinches 2. Both pinches 2 are provided with a hollow space 9, but only the hollow space 9, which lies adjacent to the coil (electrode) 5a is filled with an amalgam deposit 6.

The power supply of the amalgam lamp 20 comprises a first circuit “A”, which serves for heating the electrode 5a, and a second circuit “B”, which serves for applying the lamp voltage of nominal 100 V. The circuits “A” and “B” are part of a control device 21.

When the amalgam lamp 20 is dimmed, the nominal current Iₙₒₘᵢₙₐₗ (=8 A) in the circuit “B” is reduced. Therefore, the temperature of the electrode 5 and thus also the temperature of the amalgam deposit 6 are reduced, so that the mercury concentration in the discharge chamber 8 decreases and therefore the efficiency of the UV-C radiation decreases. In order to compensate for this effect, an additional heating current I_{add}, which leads to a temperature increase of the electrode 5a, is conducted through the electrode 5a via the circuit “A”. This temperature increase causes an additional heating of the amalgam deposit 6 arranged in the vicinity of the electrode 5a. The temperature increase of the electrode 5 is remarkable primarily because an approximately 10 times higher thermal power density prevails in the vicinity of the foot 14 than the electric arc 13 (FIG. 1) causes between the electrodes 5a, 5b.

With a reduction of the nominal current by 20% (I_{actual}=0.8×Iₙₒₘᵢₙₐₗ), the heating current I_{add} is increased such that: I_{actual}+I_{add}=Iₙₒₘᵢₙₐₗ (=100%). The control device 21 is set so that it causes, for each reduction of the nominal current, a compensation to 100% of the nominal current by a corresponding increase of the heating current.

Through this additional current, a maximum possible UV-C emission during dimmed operation is ensured.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-13. (canceled)

14. A dimmable amalgam lamp, comprising a quartz glass tube (1) enclosing a discharge chamber (8) containing a filler gas and coil-shaped electrodes (5), the quartz glass tube being closed on its two ends with pinches (2), through which at least one current feedthrough (4) is guided to each coil-shaped electrode (5) in the discharge chamber (8), wherein at least one of the pinches (2) has a hollow space (9) having an opening (7) to the discharge chamber (8) for holding an amalgam deposit (6), which is heatable by one of the coil-shaped electrodes (5), and a dimming device by which a nominal lamp current Iₙₒₘᵢₙₐₗ can be reduced to a lower actual lamp current I_{actual,} wherein the current feedthrough (4) for the one coil-shaped electrode (5) comprises an outgoing line and a return line for a heating current I_{add}, and wherein a control device (21) is provided by which the heating current I_{add} can be adjusted as a function of a level of the actual lamp current I_{actual}.

15. The amalgam lamp according to claim 14, wherein the control device is provided for adjusting the heating current “I_{add}” according to a specification of the following relationship:
½I ₙₒₘᵢₙₐₗ<I_{actual}+I_{add}<2 Iₙₒₘᵢₙₐₗ (1)

16. The amalgam lamp according to claim 14, wherein the control device is provided for adjusting the heating current “_{add}” according to a specification of the following relationship:
I_{add}+I_{actual}=Iₙₒₘᵢₙₐₗ±0.1 Iₙₒₘᵢₙₐₗ (2)

17. The amalgam lamp according to claim 14, wherein the amalgam deposit has a spacing “L” (in meters) from the coil-shaped electrode, wherein the spacing is adjusted as a function of the nominal lamp current with reference to the following equation:
\sqrt{2kIₙₒₘᵢₙₐₗ}≧L≧\sqrt{1/2kIₙₒₘᵢₙₐₗ} (3)
where Iₙₒₘᵢₙₐₗ (in Amps) is the nominal lamp current of the amalgam lamp and the constant k=0.25×10⁻³ (in m²/A).

18. The amalgam lamp according to claim 17, wherein the spacing “L” (in meters) between the amalgam deposit and coil-shaped electrode is adjusted with reference to the following equation:
L=\sqrt{kIₙₒₘᵢₙₐₗ}±0.2 \sqrt{kIₙₒₘᵢₙₐₗ} (4)

19. The amalgam lamp according to claim 14, wherein the hollow space opening (7) has an opening width that is impassable for the amalgam deposit (6).

20. The amalgam lamp according to claim 14, wherein a holding element (10; 11), which is anchored with the amalgam deposit (6), projects into the hollow space (9).

21. The amalgam lamp according to claim 20, wherein a part of the holding element (10; 11) is embedded in the pinch (2).

22. The amalgam lamp according to claim 20, wherein the holding element (10) comprises quartz glass and is guided from outside through the pinch (2) into the hollow space (9).

23. The amalgam lamp according to claim 20, wherein the holding element (11) comprises metal and is connected to a current feed line (4) for the coil-shaped electrode (5).

24. A method for operating an amalgam lamp according to claim 14 while dimmed, wherein the current feedthrough for the coil-shaped electrode comprises an outgoing line and a return line for an additional current I_{add}, and wherein the additional current I_{add} is adjusted as a function of a magnitude of the actual lamp current I_{actual}.

25. The method according to claim 24, wherein the heating current “I_{add}” is adjusted according to the specification of the following relationship:
½I ₙₒₘᵢₙₐₗ<I_{actual}+I_{add}<2 Iₙₒₘᵢₙₐₗ (1)

26. The method according to claim 25, wherein the heating current “I_{add}” is adjusted according to a specification of the following relationship:
I_{add}+I_{actual}=Iₙₒₘᵢₙₐₗ±0.1 Iₙₒₘᵢₙₐₗ (2)
